(19) United States
(12) Patent Application Publication
(10) Pub. No.: US 2019/0283743 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Koji Kawabe, Wako-shi (JP); Hideki Matsunaga, Wako-shi (JP); Masamitsu Tsuchiya, Wako-shi (JP); Yasuharu Hashimoto, Wako-shi (JP); Etsuo Watanabe, Wako-shi (JP)

(21) Appl. No.: 16/297,797

(22) Filed: Mar. 11, 2019

(30) Foreign Application Priority Data
Mar. 14, 2018 (JP) 2018-046948

(51) Int. Cl. B60W 30/09; B60W 10/04; B60W 10/20; B60W 30/095; G05D 1/02

(52) U.S. Cl. CPC B60W 30/09; B60W 10/04; B60W 10/20; G05D 2201/0213; G05D 1/0214; G05D 1/0223; B60W 2550/30; B60W 30/0956

(57) ABSTRACT

A vehicle control device includes a recognition unit that recognizes a surrounding situation including a position of another vehicle passing by a subject vehicle and a position of a retreat space in a vicinity of the subject vehicle, a retreat necessity or not determination unit that determines whether or not the other vehicle recognized by the recognition unit is required to move to the retreat space, and a driving control unit that controls acceleration or deceleration and steering of the subject vehicle based on the surrounding situation recognized by the recognition unit, and stops or decelerates the subject vehicle while directing an orientation of the subject vehicle to a side opposite to the retreat space with respect to an extending direction of a road in a case where the retreat necessity or not determination unit determines that the other vehicle is required to move to the retreat space.

### CROSS-REFERENCE TO RELATED APPLICATION

Priority is claimed on Japanese Patent Application No. 2018-046948, filed Mar. 14, 2018, the content of which is incorporated herein by reference.

### BACKGROUND

### Field of the Invention

The present invention relates to a vehicle control device, a vehicle control method, and a storage medium.

### Description of Related Art

In the related art, a support system that supports passing on a road on which it is difficult for vehicles to pass each other is known. In the related art, a technique in which inter-vehicle communication with another vehicle including an oncoming vehicle is performed by using different transmission channels for each road of a one lane road and an entry road for entering the one lane road is disclosed (for example, Japanese Unexamined Patent Application, First Publication No. 2006-254215).

### SUMMARY

However, in the related art, driving control for allowing a vehicle to smoothly pass by another vehicle by guiding the other vehicle to a predetermined space by a behavior of a subject vehicle has not been considered.

An aspect of the present invention has been made in consideration of such circumstances, and an object of the aspect of the present invention is to provide a vehicle control device, a vehicle control method, and a storage medium capable of allowing a subject vehicle to smoothly pass by another vehicle by control of a subject vehicle based on a surrounding situation.

A vehicle control device, a vehicle control method, and a storage medium according to the present invention adopt the following constitutions.

(1): A vehicle control device according to an aspect of the present invention includes a recognition unit that recognizes a surrounding situation including a position of another vehicle passing by a subject vehicle and a position of a retreat space in a vicinity of the subject vehicle, a retreat necessity or not determination unit that determines whether or not the other vehicle recognized by the recognition unit is required to move to the retreat space, and a driving control unit that controls acceleration or deceleration and steering of the subject vehicle based on the surrounding situation recognized by the recognition unit, and stops or decelerates the subject vehicle while directing an orientation of the subject vehicle to a side opposite to the retreat space with respect to an extending direction of a road in a case where the retreat necessity or not determination unit determines that the other vehicle is required to move to the retreat space.

(2): In the aspect of (1) described above, after the driving control unit changes the orientation of the subject vehicle to a side of the retreat space with respect to the extending direction of the road, the driving control unit stops or decelerates the subject vehicle while directing the orientation of the subject vehicle to the side opposite to the retreat space with respect to the extending direction of the road.

(3): In the aspect of (1) described above, in a case where a length of the retreat space along the extending direction of the road is equal to or longer than a predetermined length, the driving control unit stops or decelerates the subject vehicle while directing the orientation of the subject vehicle to the side opposite to the retreat space with respect to the extending direction of the road.

(4): In the aspect of (1) described above, the driving control unit stops or decelerates the subject vehicle while directing the orientation of the subject vehicle to the side opposite to the retreat space with respect to the extending direction of the road at a position where a front end portion of the subject vehicle exceeds an end portion of a near side of the retreat space in the extending direction of the road.

(5): In the aspect of (1) described above, in a case where it is predicted that the subject vehicle reaches the retreat space earlier than the other vehicle, the driving control unit stops or decelerates the subject vehicle while directing the orientation of the subject vehicle to the side opposite to the retreat space with respect to the extending direction of the road.

(6): A vehicle control method according to an aspect of the present invention is a vehicle control method that causes a vehicle control device to recognize a surrounding situation including a position of another vehicle passing by a subject vehicle and a position of a retreat space in a vicinity of the subject vehicle, determine whether or not the recognized other vehicle is required to move to the retreat space, control acceleration or deceleration and steering of the subject vehicle based on the recognized surrounding situation, and stop or decelerate the subject vehicle while directing an orientation of the subject vehicle to a side opposite to the retreat space with respect to an extending direction of a road in a case where it is determined that the other vehicle is required to move to the retreat space.

(7): A storage medium according to an aspect of the present invention is a computer-readable non-transitory storage medium storing a program that causes a vehicle control device to recognize a surrounding situation including a position of another vehicle passing by a subject vehicle and a position of a retreat space in a vicinity of the subject vehicle, determine whether or not the recognized other vehicle is required to move to the retreat space, control acceleration or deceleration and steering of the subject vehicle based on the recognized surrounding situation, and stop or decelerate the subject vehicle while directing an orientation of the subject vehicle to a side opposite to the retreat space with respect to an extending direction of a road in a case where it is determined that the other vehicle is required to move to the retreat space.

According to the aspects of (1) to (7) described above, it is possible to allow the subject vehicle to smoothly pass by another vehicle by control of the subject vehicle based on a surrounding situation.

### BRIEF DESCRIPTION OF THE DRAWINGS

FIG. 1 is a constitution diagram of a vehicle system using a vehicle control device according to an embodiment.

FIG. 2 is a functional constitution diagram of a first control unit and a second control unit.

FIG. 3 is a diagram showing an example of a process of a retreat space recognition unit.

FIG. 4 is a diagram showing an example of a process by a passing control unit.

FIG. 5 is a diagram for explaining an example of control until a subject vehicle M is stopped in the passing control unit.

FIG. 6 is a diagram showing an example of a target trajectory for causing the subject vehicle to travel in a passing enable space generated by the passing control unit.

FIG. 7 is a flowchart showing a flow of a process executed by an automated driving control device according to an embodiment.

FIG. 8 is a diagram showing an example of a hardware constitution of the automated driving control device according to an embodiment.

### DESCRIPTION OF EMBODIMENTS

Hereinafter, embodiments of a vehicle control device, a vehicle control method, and a storage medium of the present invention will be described with reference to the drawings. In the following, a case where a law on a left side is applied to the present invention will be described, but in a case where a law on a right side is applied to the present invention, it is only necessary to reverse a left and a right.

[Overall Constitution]

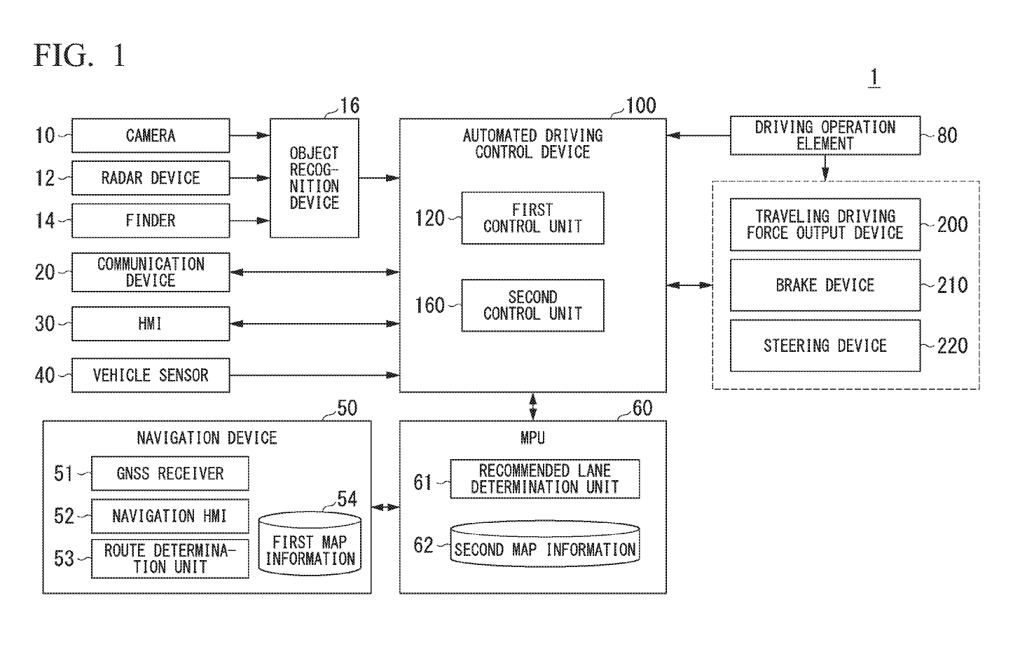

FIG. 1 is a constitution diagram of a vehicle system 1 using the vehicle control device according to the embodiment. A vehicle in which the vehicle system 1 is mounted is, for example, a vehicle such as a two-wheeled vehicle, a three-wheeled vehicle, or a four-wheeled vehicle, and a driving source of the vehicle is an internal combustion engine such as a diesel engine or a gasoline engine, an electric motor, or a combination thereof. The electric motor operates using electric power generated by a generator connected to the internal combustion engine or electric power discharged by a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map positioning unit (MPU) 60, a driving operation element 80, an automated driving control device 100, a traveling driving force output device 200, a brake device 210, and a steering device 220. Such devices and instruments are connected to each other by a multiple communication line such as a controller area network (CAN) communication line, a serial communication line, a wireless communication network, or the like. The constitution shown in FIG. 1 is merely an example, and a part of the constitution may be omitted or another constitution may be further added. The automated driving control device 100 is an example of a “vehicle control device”.

For example, the camera 10 is a digital camera using a solid imaging element such as a charge coupled device (CCD) or a complementary metal oxide semiconductor (CMOS). The camera 10 is attached to an arbitrary place on the vehicle (hereinafter, a subject vehicle M) in which the vehicle system 1 is mounted. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency modulated continuous wave (FM-CW) method.

The finder 14 is a light detection and ranging (LIDAR). The finder 14 irradiates light around the subject vehicle M and measures scattered light. The finder 14 detects the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result by a part or all of the camera 10, the radar device 12, and the finder 14 to recognize a position, a type, a speed, and the like of the object. The object recognition device 16 outputs a recognition result to the automated driving control device 100. The object recognition device 16 may output the detection result of the camera 10, the radar device 12, and the finder 14 as they are to the automated driving control device 100. The object recognition device 16 may be omitted from the vehicle system 1.

For example, the communication device 20 communicates with another vehicle that is present around the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, a key, and the like. A part or all of the navigation HMI 52 may be shared with the HMI 30 described above. For example, the route determination unit 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by the occupant. The navigation device 50 may transmit a current position and a destination to a navigation server through the communication device 20 and acquire the same route as the route on the map from the navigation server.

For example, the MPU 60 includes a recommended lane determination unit 61 and holds second map information 62 in the storage device such as an HDD or a flash memory. The recommended lane determination unit 61 divides the route on the map provided from the navigation device 50 into a plurality of blocks (for example, divides the route into intervals of 100 [m] in a vehicle progress direction), and determines a recommended lane for each block by referring to the second map information 62. The recommended lane determination unit 61 determines the number of a lane from the left that the vehicle travels in. In a case where a branching position is present in the route on the map, the recommended lane determination unit 61 determines the recommended lane so that the subject vehicle M is able to travel on a reasonable travel route for progressing to a branch destination.

The second map information 62 is map information with accuracy higher than that of the first map information 54. For example, the second map information 62 may include information on the center of a lane, information on a boundary of a lane, or the like. The second map information 62 may include road information, traffic regulation information, address information (an address and a postal code), facility information, telephone number information, and the like. The second map information 62 may include information on a retreat space where the subject vehicle M traveling on the road or another vehicle is able to temporarily retreat. The second map information 62 may be updated at any time by the communication device 20 communicating with another device.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to a part or all of the automated driving control device 100, or the traveling driving force output device 200, the brake device 210, and the steering device 220.

For example, the automated driving control device 100 includes a first control unit 120 and a second control unit 160. For example, each of such constitution elements is realized by a hardware processor such as a central processing unit (CPU) executing a program (software). Some or all of such constitution elements may be realized by hardware (a circuit unit including a circuitry) such as a large scale integration (LSI), an application specific integrated circuit (ASIC), a field-programmable gate array (FPGA), or a graphics processing unit (GPU), or may be realized by software and hardware in cooperation. The program may be stored in a storage device such as an HDD or a flash memory of the automated driving control device 100 in advance. Alternatively, the program may be stored in a detachable storage medium such as a DVD or a CD-ROM and may be installed in the HDD or the flash memory of the automated driving control device 100 by attachment of the storage medium to a drive device. A combination of the action plan generation unit 140 and the second control unit 160 is an example of a “driving control unit”. For example, the driving control unit controls acceleration or deceleration and steering of the subject vehicle M on the basis of the surrounding situation recognized by the recognition unit 130.

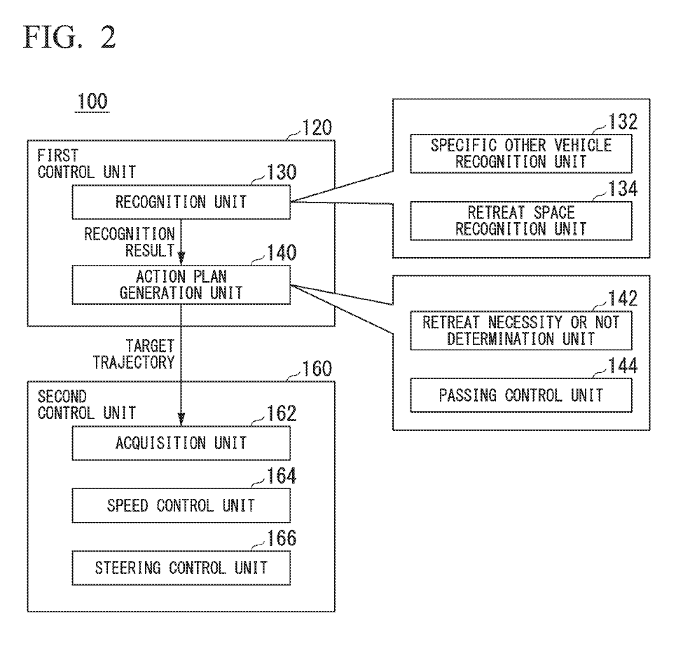

FIG. 2 is a functional constitution diagram of the first control unit 120 and the second control unit 160. For example, the first control unit 120 includes a recognition unit 130 and an action plan generation unit 140. For example, the first control unit 120 realizes a function of artificial intelligence (AI) and a function of a previously given model in parallel. For example, a function of “recognizing an intersection” may be executed in parallel with recognition of an intersection by deep learning or the like and recognition based on a previously given condition (there is a pattern matching signal, a road sign, or the like) and may be realized by giving scores to both sides and comprehensively evaluating the scores. Therefore, reliability of automated driving is guaranteed.

The recognition unit 130 recognizes states such as the position, the speed and the acceleration of the object around the subject vehicle M, on the basis of information input from the camera 10, the radar device 12, and the finder 14 through the object recognition device 16. The object includes, for example, a moving object such as a pedestrian, another vehicle, or an obstacle of a construction site or the like. For example, the position of the object is recognized as a position in absolute coordinates using a representative point (a center of gravity, a drive shaft center, or the like) of the subject vehicle M as an origin and is used in control. The position of the object may be represented by the representative point such as the center of gravity or a corner of the object, or may be represented by an expressed region. In a case where the object is another vehicle, a “state” of the object may include an acceleration or a jerk of the object, or an “action state” (for example, whether or not the object is changing lanes or trying to change lanes). In a case where the object is the pedestrian, the “state” of the object may include a direction in which the object moves, or an “action state” (for example, whether or not the object crossing the road or trying to cross the road).

For example, the recognition unit 130 recognizes a lane (road) on which the subject vehicle M is traveling. For example, the recognition unit 130 recognizes the traveling lane by comparing a pattern of a road lane marking (for example, an arrangement of a solid line and a broken line) obtained from the second map information 62 with a pattern of a road lane marking around the subject vehicle M recognized from the image captured by the camera 10. The recognition unit 130 may recognize the traveling lane by recognizing a traveling road boundary (a road boundary) including a road lane marking, a road shoulder, a curb stone, a median strip, a guard rail, and the like, and is not limited to recognizing road lane markings. In this recognition, the position of the subject vehicle M acquired from the navigation device 50 or a process result by an INS may be added. The recognition unit 130 recognizes a width of the road on which the subject vehicle M travels. In this case, the recognition unit 130 may recognize the width of the road from the image captured by the camera 10, or may recognize the width of the road from the road lane marking obtained from the second map information 62. The recognition unit 130 may recognize a width (for example, a vehicle width of the other vehicle), a height, a vehicle length, a shape, or the like of the obstacle on the basis of the image captured by the camera 10. The recognition unit 130 recognizes a temporary stop line, a red light, a toll gate, and other road events.

When recognizing the traveling lane, the recognition unit 130 recognizes the position and a posture of the subject vehicle M with respect to the traveling lane. For example, the recognition unit 130 may recognize a deviation of a representative point of the subject vehicle M from a center of the lane and an angle formed by a line connecting the center of the lane of a progress direction of the subject vehicle M as a relative position and the posture of the subject vehicle M with respect to the traveling lane. Instead of this, the recognition unit 130 may recognize a position of the representative point of the subject vehicle M with respect to one of side end portions (the road lane marking or the road boundary) of the traveling lane as the relative position of the subject vehicle M with respect to the traveling lane. The recognition unit 130 may recognize a structure (for example, a utility pole, a median strip, and the like) on the road on the basis of the first map information 54 or the second map information 62. Functions of a specific other vehicle recognition unit 132 and a retreat space recognition unit 134 of the recognition unit 130 will be described later.

In principle, the action plan generation unit 140 generates a target trajectory along which the subject vehicle M automatically (without depending on the operation of the driver) travels in the future so that the subject vehicle M travels on the recommended lane determined by the recommended lane determination unit 61 and furthermore the subject vehicle M is able to cope with the surrounding situation of the subject vehicle M. The target trajectory is a target trajectory through which the representative point of the subject vehicle M passes. The target trajectory includes, for example, a speed element. For example, the target trajectory is expressed as a sequence of points (trajectory points) where the subject vehicle M reaches. The trajectory point is a point where the subject vehicle M reaches for each predetermined traveling distance (for example, about several [m]) at a road distance, and separately from that, a target speed and a target acceleration for each predetermined sampling time (for example, about 0 comma several [sec]) are generated as part of the target trajectory. The trajectory point may be a position where the subject vehicle M will reach at a sampling time for each predetermined sampling time. In this case, information on the target speed and the target acceleration is expressed by an interval between the trajectory points.

In generating the target trajectory, the action plan generation unit 140 may set an event of the automated driving. The event of the automated driving includes a constant speed traveling event, a low speed following traveling event, a lane change event, a branch event, a merge event, a takeover event, and the like. The action plan generation unit 140 generates a target trajectory according to an activated event. Functions of a retreat necessity or not determination unit 142 and a passing control unit 144 of the action plan generation unit 140 will be described later.

The second control unit 160 controls the traveling driving force output device 200, the brake device 210, and the steering device 220 so that the subject vehicle M passes through the target trajectory generated by the action plan generation unit 140 at a scheduled time.

For example, the second control unit 160 includes an acquisition unit 162, a speed control unit 164, and a steering control unit 166. The acquisition unit 162 acquires information on the target trajectory (a trajectory point) generated by the action plan generation unit 140 and stores the information in a memory (not shown). The speed control unit 164 controls the traveling driving force output device 200 or the brake device 210 on the basis of a speed element accompanying the target trajectory stored in the memory. The steering control unit 166 controls the steering device 220 according to a degree of curvature of the target trajectory stored in the memory. For example, a process of the speed control unit 164 and the steering control unit 166 is realized by a combination of a feed-forward control and a feedback control. As an example, the steering control unit 166 is executed by a combination of a feed-forward control according to a curvature of the road ahead of the subject vehicle M and a feedback control based on the deviation from the target trajectory.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and an ECU that controls the internal combustion engine, the electric motor, the transmission, and the like. The ECU controls the above-described constitutions according to the information input from the second control unit 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second control unit 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second control unit 160 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the second control unit 160 or the information input from the driving operation element 80.

[Function of Specific Other Vehicle Recognition Unit]

For example, the specific other vehicle recognition unit 132 recognizes an oncoming vehicle that is traveling, which is present in front of the subject vehicle M and is predicted to pass by the subject vehicle M in the near future as a specific other vehicle, among other vehicles that are present in the vicinity of the subject vehicle M recognized by the recognition unit 130.

[Function of Retreat Space Recognition Unit]

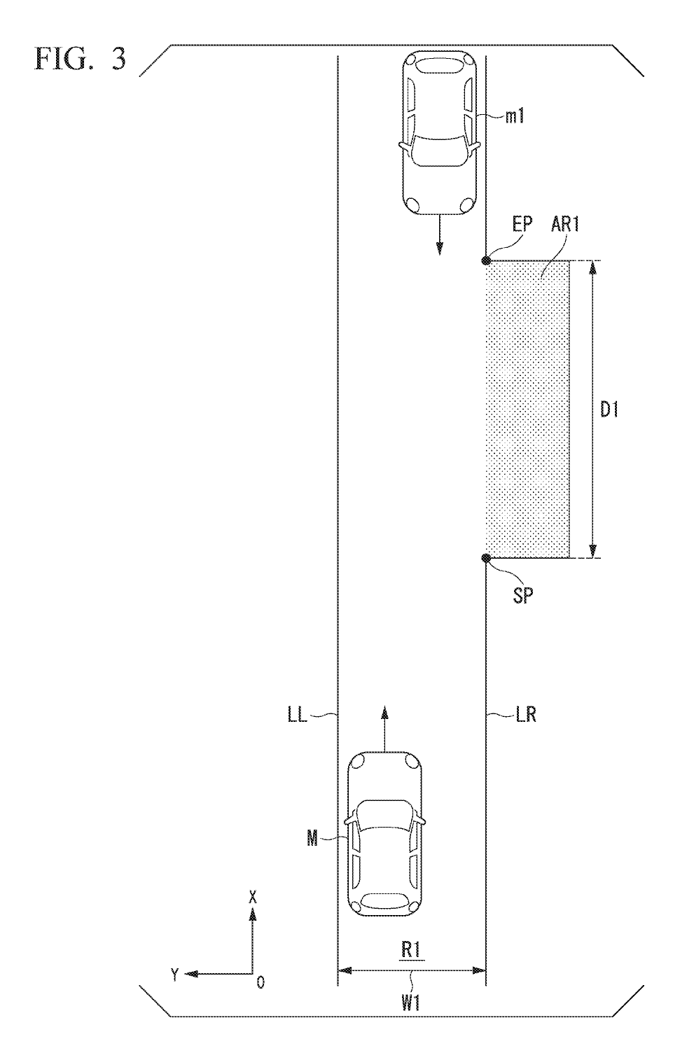

The retreat space recognition unit 134 recognizes a retreat space that is present in the vicinity of the subject vehicle M. FIG. 3 is a diagram showing an example of a process of the retreat space recognition unit 134. In the example of FIG. 3, it is assumed that the subject vehicle M travels in an extending direction (X direction in the figure) of the road R1 partitioned by left and right road lane markings LL and LR and the specific other vehicle m1 travels on the road R1 opposite to the subject vehicle M. For example, the retreat space recognition unit 134 recognizes a position of a retreat space AR1 to which a vehicle is able to enter from the road R1, which is in front of the subject vehicle M, on the basis of information input from the camera 10, the radar device 12, and the finder 14 through the object recognition device 16. For example, the position of the retreat space AR1 is a position (start position) SP of an end portion of a near side of the retreat space AR1 with respect to the extending direction of the road R1 and a position (end position) EP of an end portion of a far side as viewed from the subject vehicle M, or may be a position of each end portion forming the retreat space AR1.

The retreat space recognition unit 134 recognizes a space having a length D1 equal to or greater than a predetermined length as the retreat space AR1, among spaces along the extending direction of the road R1. For example, the predetermined length may be a length based on a vehicle length of the specific other vehicle m1 or the like (for example, about twice the vehicle length) or may be a fixed length (for example, about 10 [m]). Therefore, since driving in a case where the specific other vehicle m1 enters the retreat space AR1 from the road R1 or returns from the retreat space AR1 to the road R1 is easy, it is possible to allow the subject vehicle M to smoothly pass by the specific other vehicle m1.

For example, the retreat space recognition unit 134 recognizes a space in which the entire specific other vehicle m1 is able to be contained as the retreat space AR1. The retreat space recognition unit 134 may recognize a space to which a part of the specific other vehicle m1 is able to enter as the retreat space AR1. The space to which a part of the specific other vehicle m1 is able to enter is a space that enables the subject vehicle M to pass along the road R1 since a part of the specific other vehicle m1 enters the space.

The retreat space recognition unit 134 may refer to the position information of the second map information 62 on the basis of the position information of the subject vehicle M and recognize the retreat space AR1 from surrounding map information centering on matching position information.

The retreat space recognition unit 134 may recognize the retreat space at a timing when the specific other vehicle m1 is recognized by the specific other vehicle recognition unit 132 or may recognize the retreat space in a case where it is determined that it is necessary to retreat to the retreat space by the retreat necessity or not determination unit 142.

[Function of Retreat Necessity or Not Determination Unit]

The retreat necessity or not determination unit 142 determines whether or not the specific other vehicle m1 is required to move to the retreat space AR1 on the basis of the surrounding situation including the position of the specific other vehicle m1 and the position of the retreat space AR1. More specifically, first, the retreat necessity or not determination unit 142 determines whether or not a road width W1 of the road R1 is sufficient for the subject vehicle M and the specific other vehicle m1 to pass by face to face on the basis of a total value of the vehicle widths of the subject vehicle M and the specific other vehicle m1 (which may include a margin width) and the road width W1 of the road R1. In a case where the total value of the vehicle widths is equal to or greater than the road width W1, the retreat necessity or not determination unit 142 determines that the road width W1 of the road R1 is not sufficient for the subject vehicle M and the specific other vehicle m1 to pass by face to face. Next, in a case where the retreat necessity or not determination unit 142 determines that the road width W1 of the road R1 is not sufficient for the subject vehicle M and the specific other vehicle m1 to pass by face to face, the retreat necessity or not determination unit 142 determines whether or not the retreat space AR1 is present at a position (for example, on a right outer side of the road R1 as viewed from the subject vehicle M) closer to a traveling trajectory of the specific other vehicle m1 than to a traveling trajectory of the subject vehicle M. In a case where the retreat space AR1 is present at the position closer to the traveling trajectory of the specific other vehicle m1 than the traveling trajectory of the subject vehicle M, the retreat necessity or not determination unit 142 determines that the specific other vehicle m1 is required to move to the retreat space AR1.

On the other hand, in a case where the road width W1 of the road R1 is sufficient for the subject vehicle M and the specific other vehicle m1 to pass by face to face, or in a case where although the road width W1 of the road R1 is not sufficient for the subject vehicle M and the specific other vehicle m1 to pass by face to face, the retreat space AR1 is present at a position closer to the traveling trajectory of the subject vehicle M than to the traveling trajectory of the specific other vehicle m1 (for example, a left outer side of the road R1 as viewed from the subject vehicle M), the retreat necessity or not determination unit 142 determines that the specific other vehicle m1 is not required to move to the retreat space AR1.

[Function of Passing Control Unit]

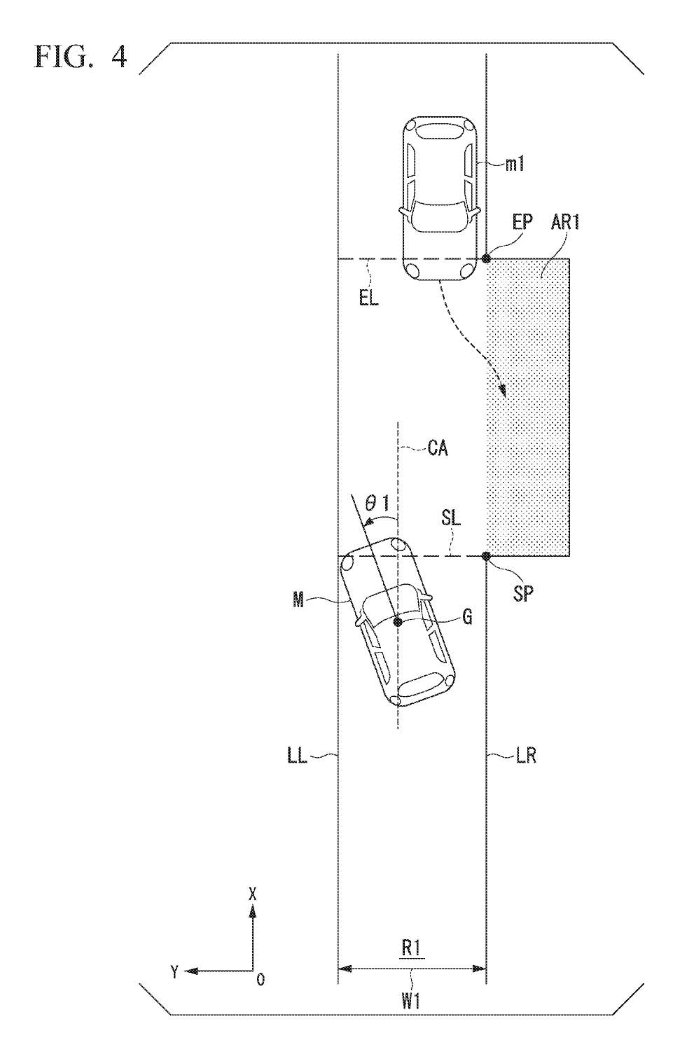

For example, in a case where it is determined that the specific other vehicle m1 is required to move to the retreat space AR1 by the retreat necessity or not determination unit 142, the passing control unit 144 guides the specific other vehicle m1 to the retreat space by the behavior of the subject vehicle M that executes driving control to pass by the specific other vehicle m1. FIG. 4 is a diagram showing an example of a process by the passing control unit 144. For example, the passing control unit 144 temporarily stops the subject vehicle M in front of the retreat space AR1, and in a case where the specific other vehicle m1 does not advance even after a predetermined time has elapsed after temporarily stops the subject vehicle M, the passing control unit 144 stops the subject vehicle M while directing an orientation of the subject vehicle M to a side opposite to the retreat space AR1 with respect to the extending direction of the road R1 at a position that is not beyond the retreat space AR1. For example, the position that does not exceed the retreat space AR1 is a position where a leading end portion of the subject vehicle M does not exceed a straight line EL extending from the position EP of the end portion of the far side of the retreat space AR1 in a road width direction (lateral direction; Y direction in the figure) as viewed from a side of the subject vehicle M.

For example, the position that does not exceed the retreat space AR1 may be a position where the front end portion of the subject vehicle M is beyond a straight line SL extending in the road width direction from the position SP of the end portion on the near side of the retreat space AR1. The position that does not exceed the retreat space AR1 may be a position in front of the straight line SL.

The passing control unit 144 may decelerate the subject vehicle M instead of stopping the subject vehicle M in the above-described driving control to pass by the specific other vehicle m1. By stopping or decelerating the subject vehicle M in the vicinity of the retreat space, it is possible to transmit, to a side of the specific other vehicle m1, facts that the retreat space AR1 for the specific other vehicle m1 is present in the vicinity of the subject vehicle M and the subject vehicle M intends to pass by the specific other vehicle m1, and a position at which the subject vehicle M passes by the specific other vehicle m1. For example, transmitting to the side of the specific other vehicle m1 is causing an object recognition device mounted on the specific other vehicle m1 to recognize the facts and the position transmitted to the specific other vehicle m1 or notifying an occupant driving the specific other vehicle m1 of the facts and the position transmitted to the specific other vehicle m1.

For example, directing the orientation of the subject vehicle M to the side opposite to the retreat space AR1 with respect to the extending direction of the road R1 is a direction facing the side opposite to the retreat space AR1 at a predetermined angle θ1 or more with respect to a center axis CA (for example, a straight line passing through a center of gravity G and extending along the extending direction of the road) of the subject vehicle M. The predetermined angle θ1 may be an angle set on the basis of the road width W1 or a fixed angle. As described above, by stopping or decelerating the subject vehicle M toward the side opposite to the retreat space AR1, it is possible to more accurately transmit, to the side of the specific other vehicle m1, the facts that the retreat space AR1 for the specific other vehicle m1 is present and the subject vehicle M intends to pass by the specific other vehicle m1. Therefore, it is possible to guide the specific other vehicle m1 to the retreat space AR1, and it is possible to realize smooth passing.

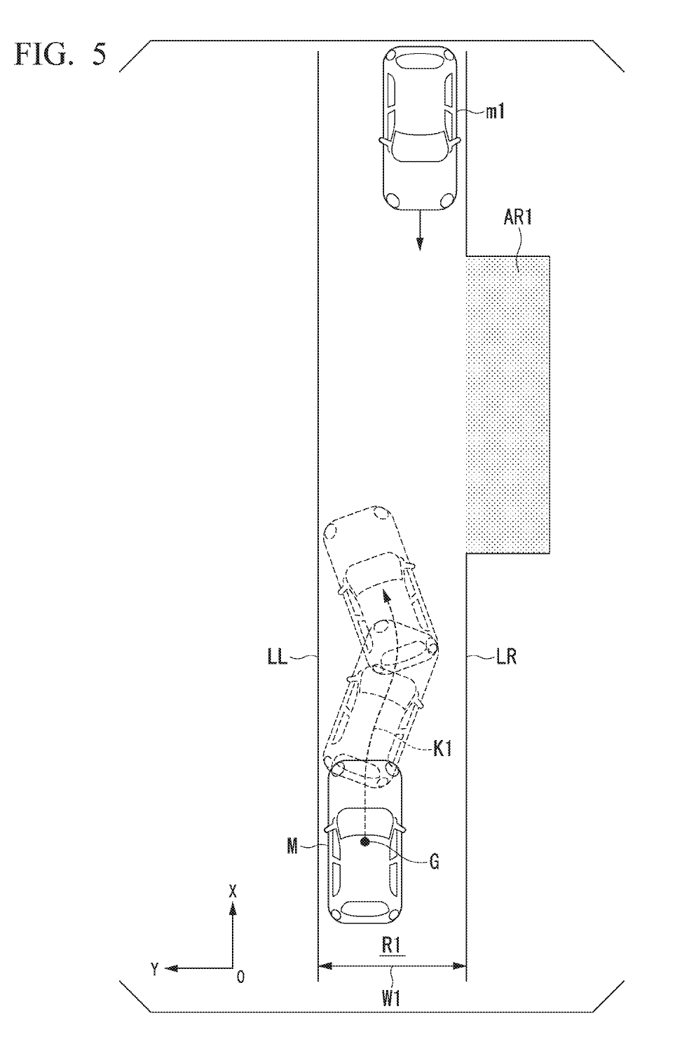

In a case where the orientation of the subject vehicle M is directed to the side opposite to the retreat space AR1 with respect to the extending direction of the road R1, the passing control unit 144 may stop the subject vehicle M toward the side opposite to the retreat space AR1 after changing the orientation of the subject vehicle M to a side of the retreat space AR1 with respect to the extending direction of the road R1. FIG. 5 is a diagram for explaining an example of the control until the subject vehicle M is stopped in the passing control unit 144. In a case where the specific other vehicle m1 is guided to the retreat space AR1, as shown in FIG. 5, the passing control unit 144 first changes the orientation of the subject vehicle M to the side of the retreat space AR1 with respect to the extending direction of the road R1 and then generates a target trajectory K1 for stopping the subject vehicle M toward the side opposite to the retreat space AR1. In a case where the orientation of the subject vehicle M is changed to the side of the retreat space AR1 with respect to the extending direction of the road R1, for example, the passing control unit 144 sets an angle directing to the retreat space AR1 on the basis of a distance from a current position of the subject vehicle M to a stop position or the road width W1, and changes the orientation of the subject vehicle M on the basis of the set angle.

As described above, in the control until the subject vehicle M stops, since it is possible to cause the subject vehicle M to turn to a large extent by directing the subject vehicle M to the side of the retreat space AR1 before the stop position of the subject vehicle M and then directing the orientation of the subject vehicle M to the side opposite to the retreat space AR1, it is possible to increase the angle to be directed to the side opposite to the retreat space AR1. Therefore, it is possible to transmit the facts that the retreat space AR1 for the specific other vehicle m1 is present and the subject vehicle M intends to pass by the specific other vehicle m1, with emphasis.

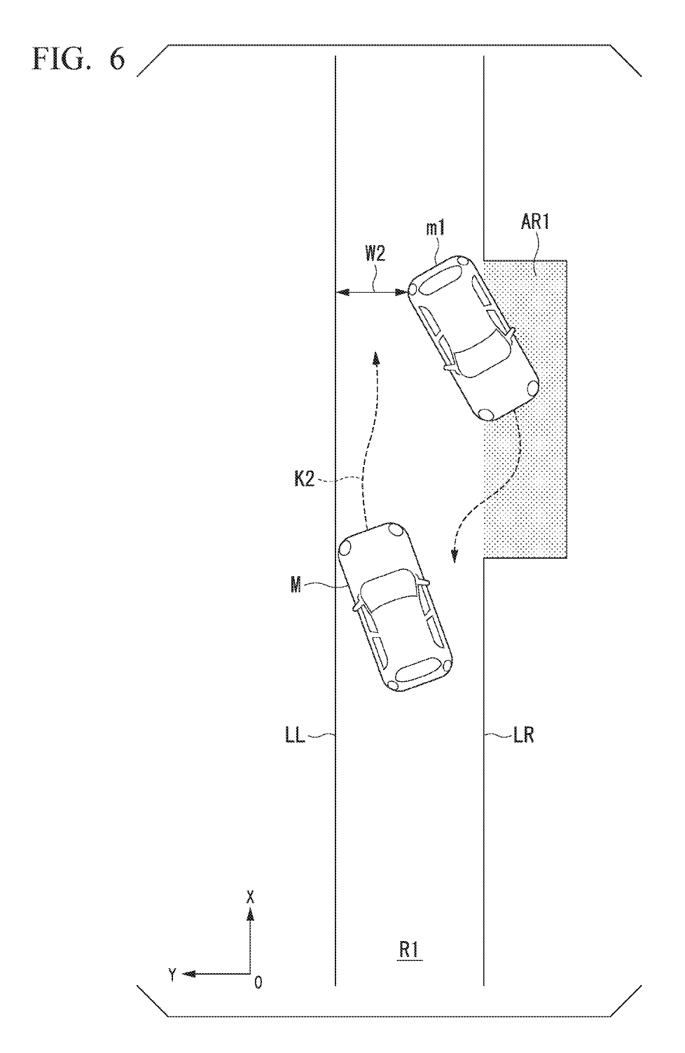

In a case where a passing enabling space where it is possible to pass by the specific other vehicle m1 is recognized by the entry of the specific other vehicle m1 to the retreat space AR1, the passing control unit 144 generates a target trajectory for the subject vehicle M to travel in the passing enable space. FIG. 6 is a diagram showing an example of a target trajectory K2 for causing the subject vehicle M to travel in the passing enable space generated by the passing control unit 144. The passing control unit 144 determines whether or not the shortest width W2 between the road lane marking LL close to the position where the subject vehicle M travels and the specific other vehicle m1 recognized by the recognition unit 130 is equal to or greater than a predetermined width Wth. For example, the predetermined width Wth is a width that allows the subject vehicle M to travel, more specifically, a width obtained by adding a predetermined margin width to the vehicle width of the subject vehicle M.

In a case where a width W2 is equal to or greater than the predetermined width Wth by the entry of the specific other vehicle m1 to the retreat space AR1, the passing control unit 144 generates a target trajectory K2 for causing the subject vehicle M to pass through a space of the width W2. Therefore, it is possible to allow the subject vehicle M to smoothly pass by the specific other vehicle m1 without making contact with the specific other vehicle m1.

Even though the specific other vehicle m1 enters the retreat space AR1, in a case where the width W2 is less than the predetermined width Wth, the passing control unit 144 may generate a target trajectory for advancing and stopping the subject vehicle M by about several [m] in a range in which the minimum interval between the subject vehicle M and the specific other vehicle m1 becomes equal to or greater than a predetermined interval. As described above, in a case where the subject vehicle M passes by the specific other vehicle m1, a space behind the subject vehicle M is increased by gradually advancing the subject vehicle M, and thus it becomes possible to easily move the specific other vehicle m1 from the retreat space AR1 to the road R1. Since the subject vehicle M and the specific other vehicle m1 are able to pass by each other while gradually advancing, it is possible to reduce a possibility of contact between the subject vehicle M and the specific other vehicle m1.

On the basis of the position and speed of the subject vehicle M and the position and speed of the specific other vehicle m1 recognized by the recognition unit 130, the passing control unit 144 may predict whether the subject vehicle M will reach the retreat space AR1 earlier than the specific other vehicle m1. In addition, in a case where it is predicted that the subject vehicle M will reach the retreat space AR1 earlier than the specific other vehicle m1, the passing control unit 144 stops or decelerates the subject vehicle M while directing the orientation of the subject vehicle M to the side opposite to the retreat space AR1 with respect to the extending direction of the road R1 at the position that does not exceed the retreat space. Therefore, in a case where the subject vehicle M first reaches the position of the retreat space, since it is possible to transmit, to the specific other vehicle m1, the facts that the retreat space AR1 for the specific other vehicle m1 is present and the subject vehicle M intends to pass by the specific other vehicle m1, and the position at which the subject vehicle M passes by the specific other vehicle m1, before the specific other vehicle m1 reaches the retreat space, by stopping the subject vehicle M toward the side opposite to the retreat space AR1, it is possible to perform smooth passing.

[Process Flow]

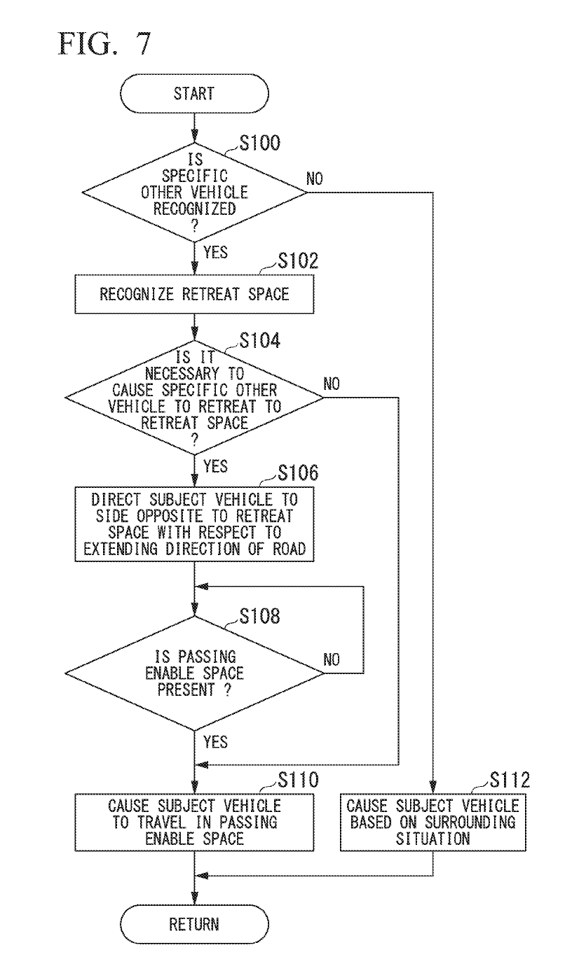

FIG. 7 is a flowchart showing a flow of a process executed by the automated driving control device 100 according to the embodiment. For example, the process of the present flowchart may be repeatedly executed at a predetermined period or at a predetermined timing. At a start of the present flowchart, it is assumed that the target trajectory is generated by action plan generation unit 140 and automated driving control is executed by the second control unit 160 on the basis of the generated target trajectory.

In the example of FIG. 7, the retreat space recognition unit 134 determines whether or not the specific other vehicle m1 has been recognized by the specific other vehicle recognition unit 132 (step S100). In a case where it is determined that the specific other vehicle m1 has been recognized by the specific other vehicle recognition unit 132, the retreat space recognition unit 134 recognizes the retreat space (step S102). Next, the retreat necessity or not determination unit 142 determines whether or not it is necessary to cause the specific other vehicle m1 to retreat to the retreat space (step S104). In a case where it is determined that it is necessary to cause the specific other vehicle m1 to retreat to the retreat space, the passing control unit 144 directs the subject vehicle M to the side opposite to the retreat space with respect to the extending direction of the road R1 (step S106). Next, the passing control unit 144 determines whether or not there is the passing enable space where it is possible to pass by the specific other vehicle m1 (step S108). In a case where it is determined that there is no passing enable space, the passing control unit 144 waits until there is the passing enable space. For example, waiting includes a state in which the subject vehicle M is stopped or a state in which the subject vehicle M is moving at a low speed for passing by the specific other vehicle m1. For example, in a case where it is determined that the specific other vehicle m1 moves to the retreat space and it is determined that there is the passing enable space, the passing control unit 144 generates the target trajectory for causing the subject vehicle M to travel in the passing enable space and causes the subject vehicle M to travel along the generated target trajectory (step S110). In the process of step S104, in a case where it is determined that it is not necessary to cause the specific other vehicle m1 to retreat to the retreat space, the passing control unit 144 causes the subject vehicle M to travel in the passing enable space (step S110).

In the process of step S100, in a case where it is determined that the specific other vehicle m1 is not recognized, the action plan generation unit 140 generates the target trajectory on the basis of the surrounding situation recognized by the recognition unit 130, and causes the subject vehicle M to travel along the generated target trajectory (step S112). Therefore, the process of the present flowchart is ended.

According to the embodiment described above, the vehicle control device includes the recognition unit (the specific other vehicle recognition unit 132 and the retreat space recognition unit 134) that recognizes the surrounding situation including the position of the other vehicle m1 passing by the subject vehicle M and the position of the retreat space in a vicinity of the subject vehicle M, the retreat necessity or not determination unit 142 that determines whether or not the specific other vehicle recognized by the recognition unit is required to move to the retreat space, and the driving control unit (the action plan generation unit 140 and the second control unit 160) that controls the acceleration or deceleration and the steering of the subject vehicle M on the basis of the surrounding situation recognized by the recognition unit, and stops or decelerates the subject vehicle M while directing the orientation of the subject vehicle M to the side opposite to the retreat space with respect to the extending direction of the road in a case where it is determined that the other vehicle m1 is required to move to the retreat space by the retreat necessity or not determination unit 142. Therefore, it is possible to allow the subject vehicle M to smoothly pass by the other vehicle by the control of the subject vehicle based on the surrounding situation.

More specifically, according to the present embodiment, in order to guide the specific other vehicle to the retreat space, the subject vehicle M is stopped or decelerated in the direction opposite to the retreat space without stopping in a straight traveling state. Therefore, it is possible to transmit, to the specific other vehicle m1, the facts that there is the retreat space for the specific other vehicle m1 and the subject vehicle M intends to pass by the specific other vehicle m1. Therefore, it is possible to realize smooth passing driving control between the subject vehicle M and the specific other vehicle m1.

In the embodiment described above, the control to pass by the specific other vehicle m1 is performed by causing the specific other vehicle m1 to retreat to the retreat space AR1. However, for example, in a case where the retreat space is present at a position closer to the traveling trajectory of the subject vehicle M than to the traveling trajectory of the specific other vehicle m1, the passing control unit 144 may perform the control to pass by the specific other vehicle m1 by causing the subject vehicle M to enter the retreat space.

[Hardware Constitution]

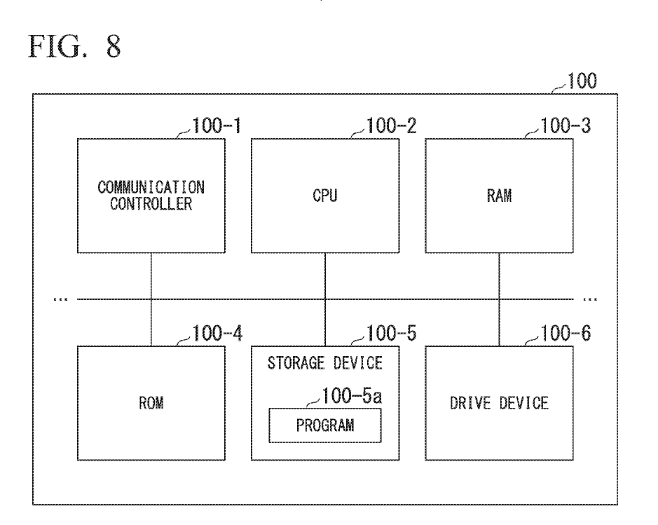

FIG. 8 is a diagram showing an example of a hardware constitution of the automated driving control device 100 according to an embodiment. As shown in the figure, the automated driving control device 100 includes a constitution in which a communication controller 100-1, a CPU 100-2, a RAM 100-3 used as a working memory, a ROM 100-4 storing a boot program and the like, a storage device 100-5 such as a flash memory or an HDD, a drive device 100-6 and the like are mutually connected by an internal bus or a dedicated communication line. The communication controller 100-1 communicates with components other than the automated driving control device 100. A portable storage medium (for example, a computer readable non-transitory storage medium) such as an optical disk is attached to the drive device 100-6. A program 100-5a executed by the CPU 100-2 is stored in the storage device 100-5. This program is developed in the RAM 100-3 by a direct memory access (DMA) controller (not shown) or the like and executed by the CPU 100-2. The program 100-5a referred to by the CPU 100-2 may be stored in the portable storage medium attached to the drive device 100-6 or may be downloaded from another device through the network. Therefore, a part or all of the first control unit 120 and the second control unit 160 of the automated driving control device 100 are realized.

The above-described embodiment is able to be expressed as follows.

A vehicle control device including:

a storage device that stores a program; and

a hardware processor,

wherein the hardware processor executes the program stored in the storage device to:

recognize a surrounding situation including a position of another vehicle passing by a subject vehicle and a position of a retreat space in a vicinity of the subject vehicle;

determine whether or not the recognized other vehicle is required to move to the retreat space;

control acceleration or deceleration and steering of the subject vehicle based on the recognized surrounding situation; and

stop or decelerate the subject vehicle while directing an orientation of the subject vehicle to a side opposite to the retreat space with respect to an extending direction of a road in a case where it is determined that the other vehicle is required to move to the retreat space.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that recognizes a surrounding situation including a position of another vehicle passing by a subject vehicle and a position of a retreat space in a vicinity of the subject vehicle;
a retreat necessity or not determination unit that determines whether or not the other vehicle recognized by the recognition unit is required to move to the retreat space; and
a driving control unit that controls acceleration or deceleration and steering of the subject vehicle based on the surrounding situation recognized by the recognition unit, and stops or decelerates the subject vehicle while directing an orientation of the subject vehicle to a side opposite to the retreat space with respect to an extending direction of a road in a case where the retreat necessity or not determination unit determines that the other vehicle is required to move to the retreat space.

2. The vehicle control device of claim 1,
wherein, after the driving control unit changes the orientation of the subject vehicle to a side of the retreat space with respect to the extending direction of the road, the driving control unit stops or decelerates the subject vehicle while directing the orientation of the subject vehicle to the side opposite to the retreat space with respect to the extending direction of the road.

3. The vehicle control device of claim 1,
wherein, in a case where a length of the retreat space along the extending direction of the road is equal to or longer than a predetermined length, the driving control unit stops or decelerates the subject vehicle while directing the orientation of the subject vehicle to the side opposite to the retreat space with respect to the extending direction of the road.

4. The vehicle control device of claim 1,
wherein the driving control unit stops or decelerates the subject vehicle while directing the orientation of the subject vehicle to the side opposite to the retreat space with respect to the extending direction of the road at a position where a front end portion of the subject vehicle exceeds an end portion of a near side of the retreat space in the extending direction of the road.

5. The vehicle control device of claim 1,
wherein, in a case where it is predicted that the subject vehicle reaches the retreat space earlier than the other vehicle, the driving control unit stops or decelerates the subject vehicle while directing the orientation of the subject vehicle to the side opposite to the retreat space with respect to the extending direction of the road.

6. A vehicle control method that causes a vehicle control device to:
recognize a surrounding situation including a position of another vehicle passing by a subject vehicle and a position of a retreat space in a vicinity of the subject vehicle;
determine whether or not the recognized other vehicle is required to move to the retreat space;
control acceleration or deceleration and steering of the subject vehicle based on the recognized surrounding situation; and
stop or decelerate the subject vehicle while directing an orientation of the subject vehicle to a side opposite to the retreat space with respect to an extending direction of a road in a case where it is determined that the other vehicle is required to move to the retreat space.

7. A computer-readable non-transitory storage medium storing a program that causes a vehicle control device to:
recognize a surrounding situation including a position of another vehicle passing by a subject vehicle and a position of a retreat space in a vicinity of the subject vehicle;
determine whether or not the recognized other vehicle is required to move to the retreat space;
control acceleration or deceleration and steering of the subject vehicle based on the recognized surrounding situation; and
stop or decelerate the subject vehicle while directing an orientation of the subject vehicle to a side opposite to the retreat space with respect to an extending direction of a road in a case where it is determined that the other vehicle is required to move to the retreat space.
